(19) United States
(12) Patent Application Publication
(10) Pub. No.: US 2019/0213307 A1
(43) Pub. Date: Jul. 11, 2019

(54) CONTENT PRESENTING METHOD AND SYSTEM

(71) Applicant: BOE TECHNOLOGY GROUP CO., LTD., Beijing (CN)

(72) Inventor: Wenbo LI, Beijing (CN)

(73) Assignee: BOE TECHNOLOGY GROUP CO., LTD., Beijing (CN)

(21) Appl. No.: 15/532,206

(22) PCT Filed: Dec. 12, 2016
(86) PCT No.: PCT/CN2016/109492

§ 371 Date: Jun. 1, 2017

(30) Foreign Application Priority Data
Jun. 21, 2016 (CN) 201610453217.7

(51) Int. Cl. G06F 21/32; G06F 16/245; G06F 21/62

(52) U.S. Cl. CPC G06F 21/32; G06F 21/6218; G06F 16/245

(57) ABSTRACT

The present disclosure provides a method and a system for presenting individualized contents to a user. The method comprises: obtaining a credential of the user, determining a level of the user based on the credential of the user, selecting a first content for presentation based on the level of the user; and presenting the first content to the user. The system comprises an acquisition portion, a control portion, and a presenting portion, wherein the control portion is coupled to the acquisition portion and the presenting portion respectively; the acquisition portion is configured to acquire a credential from a user and to send the credential to the control portion; the control portion is configured to determine a level of the user based on the credential of the user, and to select a first content for presentation based on the level of the user, and the presenting portion is configured to present the first content to the user.

### CROSS-REFERENCE TO RELATED APPLICATION

The present application claims priority to Chinese Patent Application No. 201610453217.7 filed on Jun. 21, 2016, the disclosure of which is hereby incorporated by reference in its entirety.

### TECHNICAL FIELD

The present disclosure relates generally to display technologies, specifically to a content presenting method and system, and more specifically to a method and system for presenting individualized contents to a user.

### BACKGROUND

Currently, there are mainly two types of anti-peep technologies: an eyeglass assisted type and a naked-eye type. In the eyeglass assisted type of anti-peep technologies, confidential information is protected by means of one or several auxiliary instruments (such as an eyeglass) to achieve the anti-peep protection. In the naked-eye type of anti-peep technology, the anti-peep protection is achieved by controlling the angle of the incident light.

However, under the existing anti-peep technologies, a viewer either cannot see the confidential information or can see all the confidential information, and as such, a personalized confidential display cannot be achieved.

### SUMMARY

In order to solve the aforementioned issues associated with current anti-peep technologies, the present disclosure provides a content presenting method and system, which can realize a personalized or individualized presentation.

In a first aspect, a method for presenting individualized contents to a user is disclosed. The method comprises:

obtaining a credential of the user;

determining a level of the user based on the credential of the user;

selecting a first content for presentation based on the level of the user; and

presenting the first content to the user.

Herein the credential of the user can include at least one of biometric information, a physical token, or a knowledge token. The biometric information can include at least one of face information, voice information, fingerprint information, palm information, iris information, retina information, or DNA information.

In some embodiments of the method, the determining a level of the user based on the credential of the user can comprise:

querying the credential in a user information database; and

determining the level of the user based on a result of the querying.

Herein the user information database can comprise at least one record. Each record corresponds to one pre-determined user and comprises a pre-stored credential for the one pre-determined user, and a preset level of the one pre-determined user.

In some embodiments of the method, the first content can include at least one of a visual content, an audio content, a smell content, a touch content, or a taste content.

According to some embodiments of the present disclosure, the method can further comprise:

determining characteristics information of the user based on the credential of the user;

selecting a second content based on the characteristics information of the user; and

presenting the second content to the user.

Herein the characteristics information of the user can include at least one of at least one interest, at least one hobby, gender, age, weight, or height of the user.

In a second aspect, the present disclosure further provides a system for presenting individualized contents to a user. The system comprises an acquisition portion, a control portion, and a presenting portion. The control portion is coupled to the acquisition portion and the presenting portion respectively.

The acquisition portion is configured to acquire a credential from a user and to send the credential to the control portion. The control portion is configured to determine a level of the user based on the credential of the user, and to select a first content for presentation based on the level of the user. The presenting portion is configured to present the first content to the user.

In some embodiments of the system, the acquisition portion can include a capturing sub-portion and an extraction sub-portion. The capturing sub-portion is configured to capture at least one of biometric information, a physical token, or a knowledge token, from the user; and the extraction sub-portion is configured to obtain the credential of the user based on the at least one of the biometric information, the physical token, or the knowledge token.

In some embodiments of the system, the capturing sub-portion is configured to capture the biometric information from the user, and comprises at least one capturing device, each configured to capture one type of the biometric information, selected from a group consisting of face information, voice information, fingerprint information, palm information, iris information, retina information, and DNA information.

In the embodiments of the system as described above, the at least one capturing device can include at least one of an image capturing device and a voice capturing device. The image capturing device is configured to capture at least one of the face information, the fingerprint information, the palm information, the iris information, or the retina information of the user. The voice capturing device is configured to capture the voice information of the user.

In some embodiments of the system, the control portion can include a querying sub-portion, a determining sub-portion, and a selecting sub-portion. The querying sub-portion is configured to query the credential in a user information database. The determining sub-portion is configured to determine the level of the user based on a result of querying performed by the querying sub-portion. The selecting sub-portion is configured to select the first content for presentation based on the level of the user.

Herein the user information database can include at least one record, and each record corresponds to one pre-determined user and comprises a pre-stored credential for the one pre-determined user and a preset level of the one pre-determined user.

According to some embodiments of the present disclosure, the system can further comprise a storage sub-portion, which is configured to store the user information database.

In the control portion in the system according to some embodiments of the present disclosure, each record in the user information database can further include pre-stored characteristics information of the one pre-determined user, the determining sub-portion is configured to further determine characteristics information of the user based on a result of the querying performed by the querying sub-portion, and the selecting sub-portion is configured to further select a second content for presentation based on the characteristics information of the user.

Herein the characteristics information of the user can include at least one of at least one interest, at least one hobby, gender, age, weight, or height of the user.

In some embodiments of the system, the first content can comprise at least one of a visual content, an audio content, a smell content, a touch content, or a taste content; and correspondingly, the presenting portion can comprise at least one presenting device, each configured to present one of the visual content, the audio content, the smell content, the touch content, or the taste content.

In one embodiment of the system as described above, the first content can comprise a visual content; and the presenting portion can comprise a display panel, configured to present the visual content.

In the system as described above, the control portion can be disposed in a local computer, or in a remote server.

In the system as described above, the control portion can be respectively coupled to the acquisition portion and the presenting portion via at least one of a wired connection or a wireless connection.

Other embodiments may become apparent in view of the following descriptions and the attached drawings.

### BRIEF DESCRIPTION OF THE DRAWINGS

To more clearly illustrate some of the embodiments, the following is a brief description of the drawings. The drawings in the following descriptions are only illustrative of some embodiment. For those of ordinary skill in the art, other drawings of other embodiments can become apparent based on these drawings.

FIG. 1 is a flow chart illustrating a method for presenting individualized contents to a user according to some embodiments of the present disclosure;

FIG. 2 is a diagram illustrating the working principle of a method for presenting individualized contents to a user according to some embodiments of the present disclosure;

FIG. 3 is a schematic diagram of the structure of a system for presenting individualized contents to a user according to some embodiments of the present disclosure;

FIG. 4 is a diagram illustrating the working principles of a system for presenting individualized contents to a user according to some embodiments of the present disclosure;

FIG. 5 is a schematic diagram of a system for presenting individualized contents to a user according to some embodiments of the present disclosure.

### DETAILED DESCRIPTION

In the following, with reference to the drawings of various embodiments disclosed herein, the technical solutions of the embodiments of the disclosure will be described in a clear and fully understandable way.

It is obvious that the described embodiments are merely a portion but not all of the embodiments of the disclosure. Based on the described embodiments of the disclosure, those ordinarily skilled in the art can obtain other embodiment(s), which come(s) within the scope sought for protection by the disclosure.

In a first aspect, the present disclosure provides a method for presenting individualized contents to a user. In the method, first a credential of the user is obtained, next a content for presentation is selected based on the credential of the user; and finally, the content is presented to the user. Herein the credential is substantially identification information of the user and can comprise at least one of biometric information, a physical token, or a knowledge token. Herein the content can include at least one of a visual content, an audio content, a smell content, a touch content, or a taste content.

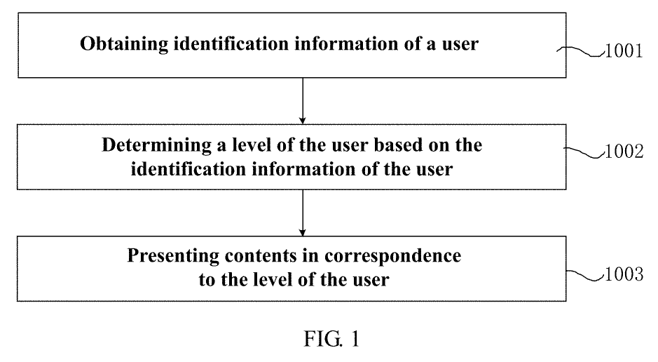

FIG. 1 is a flow chart illustrating a method for presenting individualized contents to a user according to some embodiments of the present disclosure. As shown in FIG. 1, the content presenting method comprises:

Step 1001: Obtaining identification information of a user.

In some embodiments of the method, the step of obtaining identification information of a user can comprise the following sub-steps:

Capturing biometric information of the user; and

Extracting the identification information of the user based on the biometrics information or iris information.

In these embodiments of the method, the identification information of the user is obtained mainly from biometric information of the user that has been captured. The biometric information of a user can include at least one of the following types: face information, voice information, fingerprint information, palm information, iris information, retina information, or DNA information.

It is noted that besides the biometric information, other types of identification information used for identification recognition, such as a physical token (e.g. an identification card) or a knowledge token (e.g. a password), can also be employed in the method. There are no limitations herein.

Step 1002: selecting a content for presentation based on the identification information of the user.

In some embodiments of the method, selecting a content for presentation based on the identification information of the user can include: determining a level of the user based on the identification information of the user; and selecting a content based on the level of the user.

Before determining a level of the user based on the identification information of the user, other relevant information needs to be pre-determined, preset, and pre-stored in a database. For this purpose, the identification information of each of at least one pre-determined user can be first obtained, next the level of each pre-determined user can be pre-set according to practical needs. After that, the identification information and the corresponding level for each pre-determined user can be combined to form user level information, stored as a record in a user information database.

As such, determining a level of the user based on the identification information of the user can comprise: querying the identification information in a user information database; and determining a level of the user based on a result of the querying.

As such, in these embodiments of the method, the identification information of the user that is obtained in Step 1001 can matched, or compared, with the user level information of pre-determined users that has been preset and pre-stored in the user information database.

Whatever level that is returned after querying is the level of the user. For example, if a matching result returns a highest level, the level of the user is determined as the highest level; and if a matching result returns a lowest level, the level of the user is determined as the lowest level. Herein levels of users can be based on information regarding whether the user is an internal employee, a guest, a VIP member, or a manager, etc. However, other possibilities exist as well, and there are no limitations herein.

After the level of the user has been determined, the contents for presentation can be presented to the user in Step 1003. Herein the contents are substantially level-specific contents.

In some embodiments of the method, beside the level-specific contents (i.e. the first contents), the content for presentation can further contain user characteristics-specific content (i.e. second contents). Herein the characteristics information of a user can include interests, hobbies, gender, age, weight, height, etc. of the user.

Similar to the preset level information, the characteristics information of each pre-determined user can also be collected in advance and stored in one record of user level information in the user information database. As such, in the method, selecting a content for presentation based on the identification information of the user further comprises: determining a level of, and characteristics information, of the user based on the credential of the user; and selecting the content based on the characteristics information of the user, wherein the content comprises a first content and a second content, corresponding respectively to the level, and to the characteristics information of the user.

Step 1003: Presenting the content to the user;

In the method, the content can include the first content and optionally the second content, and needs to be pre-determined and pre-formed.

In the method as described above, the first content(s) corresponding to the level of a user and optionally the second contents based on the user characteristics information of the same user are presented to the user. Thereby, the content presenting method as illustrated above can present personalized or individualized contents to different users, by which advertisements for recommending relevant products and services can be personalized among different users.

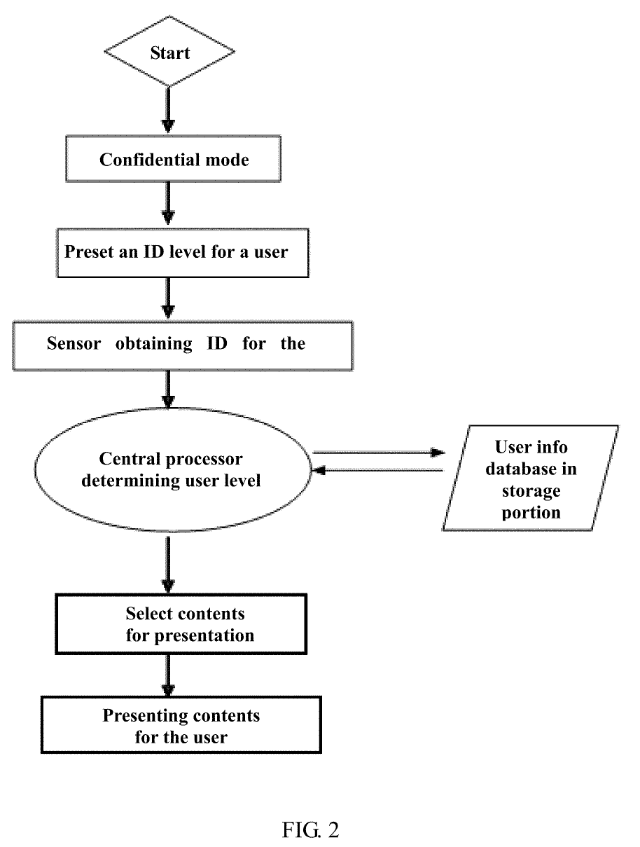

FIG. 2 is a diagram illustrating the working principle of a personalized content presenting method according to some embodiments of the present disclosure. The personalized content presenting method can be utilized, for example, to display personalized contents on a display panel to a user.

As shown in FIG. 2, after starting, the system enters into a confidential mode, wherein a level is pre-assigned for a user. A capturing device (i.e. a sensor) can then capture the identification information of the user. After the identification information of the user is captured, a control portion (i.e. a central processor) can determine the level of the user by querying the identification information of the user in a user information database that is pre-stored in a storage portion, then it can further select the first contents corresponding to the level of the user, and finally it can issue commands to transmit the first contents that have been selected to a display screen for the user to view.

Optionally the control portion can also select the second contents for displaying to the user based on the characteristics information of the user (not shown in the drawings) that has been pre-stored in in a user information database in a storage portion.

Herein the first contents corresponding to a level of a user and the second content corresponding to characteristics information of the user can be formed in advance and stored in the storage portion, but can also be stored in a different place. There are no limitations herein.

In summary of the above, the method for presenting individualized contents to a user as described above substantially comprises: first obtaining identification information of a user; then determining a level (and optionally characteristics information) of the user and selecting a content for presentation; and finally presenting the content to the user.

As such, different contents can be displayed to different users, thereby realizing a confidential display (i.e. user level-specific display) and a smart display (i.e. user characteristics-dependent display) for users.

It should be noted that besides display contents as exemplified above, the contents for presenting can be of other types, such as audio contents, smell contents, or other contents. There are no limitations herein.

In a second aspect, the present disclosure provides a system for presenting individualized contents to a user that substantially apply any of the embodiments of the method for presenting individualized contents to a user as described above.

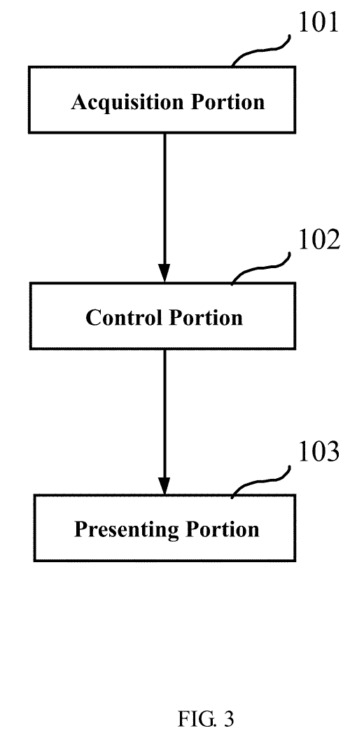

The system can comprise an acquisition portion 101, a control portion 102, and a presenting portion 103, as illustrated in FIG. 3. The control portion 102 is respectively coupled to the acquisition portion 101 and the presenting portion 103. The acquisition portion 101 is configured to acquire a credential from a user and to send the credential to the control portion. The control portion 102 is configured to select a content for presentation upon receiving the credential from the acquisition portion 101. The presenting portion 103 is configured to present the content to the user.

Herein the credential is substantially identification information of the user and can comprise at least one of biometric information, a physical token, or a knowledge token. Herein the content can include at least one of a visual content, an audio content, a smell content, a touch content, or a taste content.

In some embodiments of the system, the acquisition portion 101 can include a capturing sub-portion and an extraction sub-portion. The capturing sub-portion is configured to capture biometric information of a user. The extraction sub-portion is configured to extract the identification information of the user from the biometrics information of the user that has been acquired by the acquisition portion.

In the system as disclosed herein, besides the biometric information, such as face information, voice information, or iris information of the user, the identification information can also include other types of credentials, such as a physical token (e.g. an identification card) or a knowledge token (e.g. a password), can also be employed in the system. There are no limitations herein.

In some embodiments of the present disclosure, the system can further include a first setting portion and a first forming portion. The first setting portion is configured to pre-set a level of each pre-determined user; and the first forming portion is configured to form a record of user level information for each pre-determined user based on the identification information and the corresponding level of the user. Preferably, the at least one record of user level information for pre-determined users can be stored in a user information database.

In the system, the control portion 102 can include a querying sub-portion, a determining sub-portion, and a selecting sub-portion. The querying sub-portion is configured to query the identification information of a user in the user information database having pre-stored user level information. Or in other words, the querying sub-portion is configured to match, or compare, the identification information of a user with the preset user level information pre-stored in the user information database.

The determining sub-portion is configured to determine a level of the user based on a result of the querying performed by the querying sub-portion. The selecting sub-portion is configured to select the content for presentation based on the level of the user.

Herein the querying sub-portion queries the identification information of the user in the user information database. If the query result returns a highest level, the determining sub-portion determines that the level of the user is the highest level; and if the query result returns a lowest class, the determining sub-portion determines that the level of the user is the lowest level.

In some embodiments of the present disclosure, optionally the system can further include a second acquisition portion and a second forming portion. The second acquisition portion is configured to obtain characteristics information of each pre-determined user, and the second forming portion is configured to form a record of user level information in the user information database for each pre-determined user based on the identification information and the characteristics information of the user.

In the system, the presenting portion 103 can present contents such as visual contents, an audio contents, smell contents, touch contents, or taste contents. In some embodiments of the system, the presenting portion 103 can be a display panel, configured to display visual contents that have been transmitted from the control portion 102.

The system can further include a storage portion (not shown in FIG. 3), which is coupled with the control portion 103 and is configured to store the user information database. Optionally the first contents in correspondence to a level of a user, and/or the second contents in correspondence to characteristics information of a user can also be stored in the storage portion, but can also be stored somewhere else, such as a second storage portion.

As such, under control of the control portion 102, the first contents corresponding to a level of a user and optionally the second contents corresponding to characteristics information of the user can be presented to the user via the presenting portion 103 upon a user's biometrics information is captured by the acquisition portion 101. Thereby personalized contents, such as customized advertisements, can be presented to different users based on the level and characteristics of each user.

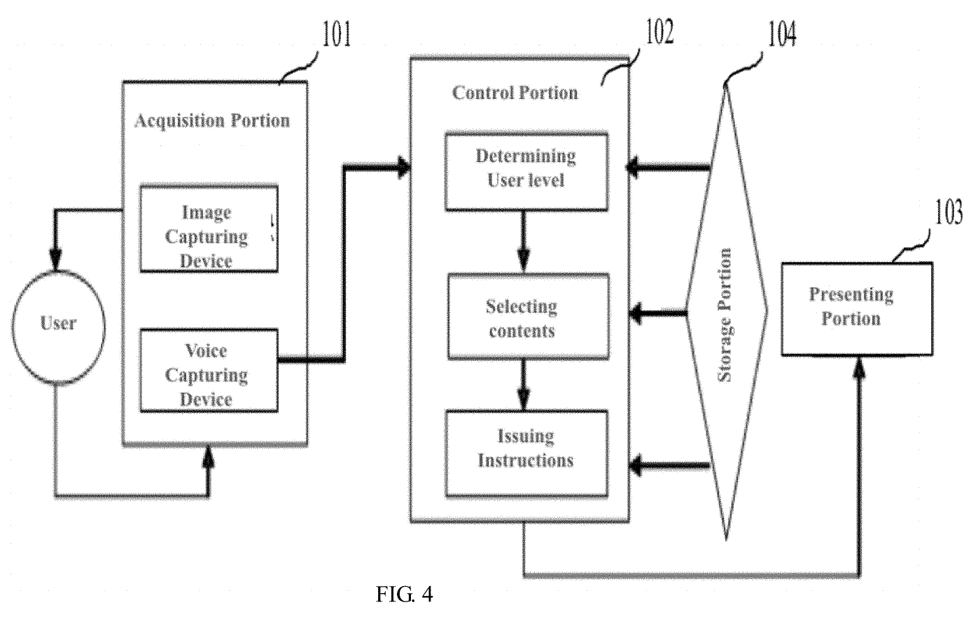

FIG. 4 is a diagram illustrating the working principle of a system for presenting individualized contents to a user according to some embodiment of the present disclosure.

As shown in FIG. 4, when a user is in front of a confidential display screen, the acquisition portion 101 obtains the identification information of the user. As such, a capturing sub-portion in the acquisition portion 101 can be first utilized to capture the biometric information of the user. The capturing sub-portion can comprise an image capturing device and a voice capturing device, as illustrated in FIG. 4. Beside the image capturing device and a voice capturing device, the capturing sub-portion can comprise other types of biometric information capturing devices, such as an iris capturing device (not shown in the figure). An extraction sub-portion in the acquisition portion 101 (not shown in the figure) can then be used to extract the identification information of the user based on the biometric information captured by the capturing sub-portion.

After the acquisition portion 101 obtains the identification information of the user, the control portion 102 can first determine the level of the user by querying the identification information of the user in a user information database stored in a storage portion 104, can then select the first contents corresponding to the level of the user (and optionally the second contents corresponding to the characteristics of the user), and can finally issue instructions to transmit the first contents (and optionally the second contents) to the presenting portion 103 for presentation to the user.

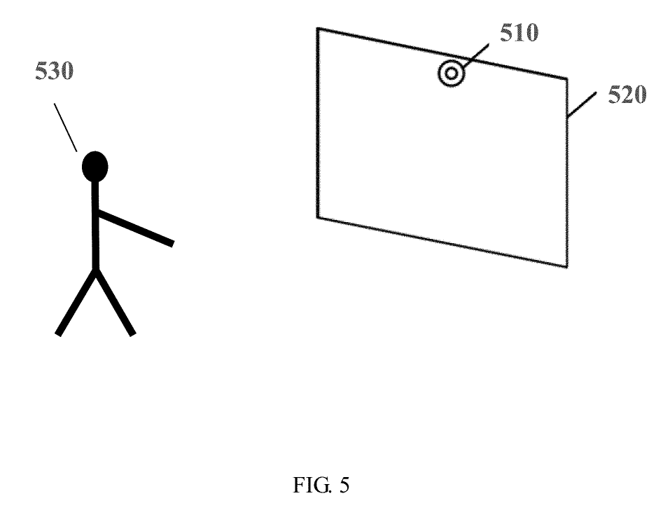

The system as described above in FIG. 4 can be specifically used for displaying individualized or personalized contents in a display panel to a user standing in the front based on the level and characteristics of the user. As illustrated in FIG. 5, an image capturing device (e.g. a camera) 510, disposed on an upper middle portion of a display panel 520, can capture the image of a user 530 in front of the display panel 520, then the image can be used to determine the level and characteristics of the user in a control portion of the content presenting system (not shown in FIG. 5). After selecting the contents for display (including the first and optionally the second contents) based on the level and characteristics of the user, the control portion sends the contents to the display panel 520 for display to the user 530.

The technical solutions provided by this embodiment of the present disclosure determine the user class of the current user through identification verification, then display corresponding display contents according to the user class, therefore, it displays different display contents to users of different identification (ID)s, and therefore the purpose of confidential display is achieved. Therefore, the technical solutions provided by this embodiment can provide the user more choices while achieving confidential display.

All references cited in the present disclosure are incorporated by reference in their entirety. Although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

1. A method for presenting individualized contents to a user, comprising:
obtaining a credential of the user;
determining a level of the user based on the credential of the user;
selecting a first content for presentation based on the level of the user; and
presenting the first content to the user.

2. The method of claim 1, wherein the credential of the user comprises at least one of biometric information, a physical token, or a knowledge token.

3. The method of claim 2, wherein the credential of the user comprises the biometric information, wherein the biometric information comprises at least one of face information, voice information, fingerprint information, palm information, iris information, retina information, or DNA information.

4. The method of claim 1, wherein the determining a level of the user based on the credential of the user comprises:
querying the credential in a user information database; and
determining the level of the user based on a result of the querying;
wherein:
the user information database comprises at least one record, each record corresponding to one pre-determined user and comprising:
a pre-stored credential for the one pre-determined user; and
a preset level of the one pre-determined user.

5. The method of claim 1, wherein the first content comprises at least one of a visual content, an audio content, a smell content, a touch content, or a taste content.

6. The method of claim 3, further comprising:
determining characteristics information of the user based on the credential of the user;
selecting a second content based on the characteristics information of the user; and
presenting the second content to the user.

7. The method of claim 6, wherein the characteristics information of the user comprises at least one of at least one interest, at least one hobby, gender, age, weight, or height of the user.

8. A system for presenting individualized contents to a user, comprising:
an acquisition portion;
a control portion; and
a presenting portion;
wherein:
the control portion is coupled to the acquisition portion and the presenting portion respectively;
the acquisition portion is configured to acquire a credential from a user and to send the credential to the control portion;
the control portion is configured to determine a level of the user based on the credential of the user, and to select a first content for presentation based on the level of the user; and
the presenting portion is configured to present the first content to the user.

9. The system of claim 8, wherein the acquisition portion comprises:
a capturing sub-portion, configured to capture at least one of biometric information, a physical token, or a knowledge token, from the user; and
an extraction sub-portion, configured to obtain the credential of the user based on the at least one of the biometric information, the physical token, or the knowledge token.

10. The system of claim 9, wherein the capturing sub-portion is configured to capture the biometric information from the user, and comprises at least one capturing device, each configured to capture one type of the biometric information, selected from a group consisting of face information, voice information, fingerprint information, palm information, iris information, retina information, and DNA information.

11. The system of claim 10, wherein the at least one capturing device comprises at least one of:
an image capturing device, configured to capture at least one of the face information, the fingerprint information, the palm information, the iris information, or the retina information of the user; and
a voice capturing device, configured to capture the voice information of the user.

12. The system of claim 8, wherein the control portion comprises:
a querying sub-portion, configured to query the credential in a user information database;
a determining sub-portion, configured to determine the level of the user based on a result of querying performed by the querying sub-portion; and
a selecting sub-portion, configured to select the first content for presentation based on the level of the user.

13. The system of claim 12, wherein the user information database comprises at least one record, wherein each record corresponds to one pre-determined user and comprises:
a pre-stored credential for the one pre-determined user; and
a preset level of the one pre-determined user.

14. The system of claim 13, further comprising a storage sub-portion, configured to store the user information database.

15. The system of claim 13, wherein in the control portion,
each record in the user information database further comprises pre-stored characteristics information of the one pre-determined user;
the determining sub-portion is configured to further determine characteristics information of the user based on a result of the querying performed by the querying sub-portion; and
the selecting sub-portion is configured to further select a second content for presentation based on the characteristics information of the user.

16. The system of claim 15, wherein the characteristics information of the user comprises at least one of at least one interest, at least one hobby, gender, age, weight, or height of the user.

17. The system of claim 8, wherein:
the first content comprises at least one of a visual content, an audio content, a smell content, a touch content, or a taste content; and
the presenting portion comprises at least one presenting device, each configured to present one of the visual content, the audio content, the smell content, the touch content, or the taste content.

18. The system of claim 17, wherein:
the first content comprises a visual content; and
the presenting portion comprises a display panel, configured to present the visual content.

19. The system of claim 8, wherein the control portion is disposed in a local computer, or in a remote server.

20. The system of claim 8, wherein the control portion is respectively coupled to the acquisition portion and the presenting portion via at least one of a wired connection or a wireless connection.
